(19) United States
(12) Patent Application Publication
(10) Pub. No.: US 2025/0154393 A1
(43) Pub. Date: May 15, 2025

(54) EPOXY WATERPROOF ADHESIVE MATERIAL AND PREPARATION METHOD AND USE THEREOF

(71) Applicants: GUANGZHOU MUNICIPAL ENGINEERING MAINTENANCE CO.,LTD, Guangzhou (CN); GUANGZHOU SHIWEI NEW MATERIAL TECHNOLOGY CO., LTD, Guangzhou (CN)

(72) Inventors: Kaizhi SU, Guangzhou (CN); Chengsheng HU, Guangzhou (CN); Changyu YIN, Guangzhou (CN); Zhonggao LIANG, Guangzhou (CN); Xinyan PENG, Guangzhou (CN); Yuchi XIE, Guangzhou (CN); Zengwen DONG, Guangzhou (CN); Yongwen LIN, Guangzhou (CN); Long XU, Guangzhou (CN)

(21) Appl. No.: 19/021,385

(22) Filed: Jan. 15, 2025

Related U.S. Application Data
(63) Continuation of application No. PCT/CN2024/110042, filed on Aug. 6, 2024.

(30) Foreign Application Priority Data
Aug. 10, 2023 (CN) 202311001205.7

(51) Int. Cl. C09J 163/00; C09J 5/00; C09J 9/00; C09J 11/08

(52) U.S. Cl. CPC C09J 163/00; C09J 5/00; C09J 9/00; C09J 11/08

(57) ABSTRACT

Provided are an epoxy waterproof adhesive material and a preparation method and use thereof. The epoxy waterproof adhesive material includes a component A and a component B in a mass ratio of 1:(0.8-1.2). The component A comprises the following raw materials in parts by mass: 100 parts of an epoxy resin, 2 parts to 10 parts of a reactive diluent, and 0.5 part to 1.5 parts of an adhesion promoter; and the component B comprises the following raw materials in parts by mass: 4 parts to 12 parts of a curing accelerator, 70 parts to 85 parts of a curing agent, and 8 parts to 20 parts of a liquid rubber.

### CROSS-REFERENCE TO RELATED APPLICATION

The present application is a continuation-in-part application of International Patent Application No. PCT/CN2024/110042, filed on Aug. 6, 2024, which claims priority to Chinese Patent Application No. 202311001205.7 filed with the China National Intellectual Property Administration (CNIPA) on Aug. 10, 2023 and entitled “EPOXY WATERPROOF ADHESIVE MATERIAL AND PREPARATION METHOD AND USE THEREOF”. The disclosure of the two applications is incorporated herein by reference in its entirety.

### TECHNICAL FIELD

The present disclosure belongs to the field of waterproof materials, and in particular to an epoxy waterproof adhesive material and a preparation method and use thereof.

### BACKGROUND

With rapid development of transportation industry in China, various bridges have emerged in recent years. The bridge deck pavement of steel bridges, especially large-span steel bridges, has gradually become a technical difficulty in highway construction. A bridge deck pavement system is an important part of the bridge, and a quality and service life of the bridge deck pavement system are directly related to safety and comfortability of traffics and durability and economic benefits of the bridge. Steel bridge deck pavement generally includes an upper layer, a lower layer, a waterproof layer, an adhesive layer, and an anti-rust layer. Currently, the waterproof layer and the adhesive layer are often combined into one layer, namely, a waterproof adhesive layer. The waterproof adhesive layer is an important part of bonding a bridge deck and a bituminous mix surface course into a whole. Due to special stress conditions, working environments, and service conditions of the bridge decks, the waterproof adhesive layer needs to meet extremely-high requirements. The waterproof adhesive layer must exhibit both excellent deformability and interlayer adhesion and prominent water resistance. Materials for the waterproof adhesive layer play a crucial role in durability of a bridge itself and a pavement layer. Defects or absence of the waterproof adhesive layer can easily cause damage to the pavement layer, which affects the service life of the pavement layer and the bridge.

CN115537161A discloses an epoxy resin waterproof adhesive layer material for a steel bridge. This patent is intended to solve the problem that current waterproof adhesive materials on the market have disadvantages such as high price, insignificant waterproof effect, and large brittleness of cured materials. CN113429160A discloses a waterproof adhesive layer for bridge deck pavement and a construction method thereof. In view of the problems such as poor waterproof effect, poor durability, and easy fall-off under rolling of current waterproof adhesive layers, this patent provides a targeted improvement and a corresponding construction method. CN109608893A discloses a waste tire crumb rubber asphalt material for a waterproof adhesive layer of a bridge deck pavement and a preparation method thereof. This patent tries to reduce volatilization and consumption of a curing agent during use by reducing a curing temperature of an epoxy resin. CN111423846A discloses a material for a waterproof adhesive layer of bridge and tunnel pavements and a preparation method and use thereof. The material has characteristics such as moderate cost, adjustable curing time, prominent toughness, high bonding strength, excellent impact resistance and waterproofness, and superior durability, and could be prepared by a simple process.

Due to special service conditions, waterproof adhesive materials are required to have prominent adhesion, mechanical strength, and flexibility and curing characteristics matching construction other than excellent waterproofness. However, the above-mentioned patents have deficiencies in bonding or curing characteristics, and cannot ensure the durability of interlayer bonding and waterproofness of the waterproof adhesive layers under an action of environments and traffic loads during use.

### SUMMARY

In order to overcome the shortcomings and deficiencies in the prior art, a primary object of the present disclosure is to provide an epoxy waterproof adhesive material. The epoxy waterproof adhesive material has excellent interfacial adhesion, high strength, prominent flexibility, and excellent waterproofness, and could be re-liquefied at a high temperature after initially being cured.

Another object of the present disclosure is to provide a method for preparing the epoxy waterproof adhesive material described above.

Yet another object of the present disclosure is to provide use of the epoxy waterproof adhesive material described above.

The objects of the present disclosure are achieved by the following technical solutions.

An epoxy waterproof adhesive material is provided, including (or consisting of) a component A and a component B, with a mass ratio of the component A to the component B being a range of 1:(0.8-1.2), where
the component A includes (or consists of) the following raw materials in parts by mass:

| | |
|---|---|
| an epoxy resin | 100 parts |
| a reactive diluent | 2 parts to 10 parts, and |
| an adhesion promoter | 0.5 part to 1.5 parts; and |

the component B includes (or consists of) the following raw materials in parts by mass:

| | |
|---|---|
| a curing accelerator | 4 parts to 12 parts |
| a curing agent | 70 parts to 85 parts, and |
| a liquid rubber | 8 parts to 20 parts. |

The epoxy resin is a bisphenol F epoxy resin; and the reactive diluent is at least one selected from the group consisting of ethylhexyl glycidyl ether, ethylene glycol diglycidyl ether, and alkyl (C12-C14) glycidyl ether (AGE).

The bisphenol F epoxy resin is GEFR 170 (a bisphenol F epoxy resin produced by Zhuhai Hongchang Electronic Materials Co., Ltd., China).

The adhesion promoter is at least one selected from the group consisting of 2-(3,4-epoxycyclohexyl) ethyltrimethoxysilane (A-186) and a polyester Tech-7205 (a special polyester compound produced by Shanghai Tiger Polymer Technology Co., Ltd., China).

The curing accelerator is at least one selected from the group consisting of a tertiary amine accelerator 2,4,6-tri(dimethylaminoethyl)phenol (DMP-30) and a polyetheramine accelerator 9133 (produced by Shanghai Haoshang Chemical Co., Ltd., China); the curing agent is oleylamine; and the liquid rubber is an amino-terminated liquid nitrile rubber ATBN 1300×16.

A method for preparing the epoxy waterproof adhesive material described above is provided, including the following steps:
(1) weighing 100 parts by mass of the epoxy resin, 2 parts by mass to 10 parts by mass of the reactive diluent, and 0.5 part by mass to 1.5 parts by mass of the adhesion promoter, and mixing to obtain the component A;
(2) weighing 4 parts by mass to 12 parts by mass of the curing accelerator, 70 parts by mass to 85 parts by mass of the curing agent, and 8 parts by mass to 20 parts by mass of the liquid rubber, and mixing to obtain the component B; and
(3) mixing the component A and the component B in the mass ratio of 1: (0.8-1.2) to obtain the epoxy waterproof adhesive material.

Use of the epoxy waterproof adhesive material described above in a waterproof adhesive layer for a steel bridge deck or a concrete bridge deck is provided.

Compared with the prior art, embodiments of the present disclosure have the following advantages and effects.
(1) High strength, prominent flexibility, and adjustable performance: In the present disclosure, a monoamine-based curing agent oleylamine and an amino-terminated liquid nitrile rubber ATBN 1300×16 are introduced, such that a material has excellent flexibility and low-temperature toughness, a high strength, and adjustable performance.
(2) Excellent interfacial adhesion: In the present disclosure, the oleylamine as a long-chain aliphatic amine curing agent and a mixture of 2-(3,4-epoxycyclohexyl)ethyltrimethoxysilane (A-186) and a polyester Tech-7205 as a reactive group-containing adhesion promoter are introduced to effectively improve the interfacial adhesion of the material to steel and concrete substrates.
(3) Wide applicability: Through optimization design for material selection and a formula, the present disclosure could be used in waterproof adhesive layers for steel bridge decks or cement concrete bridge decks.
(4) Re-liquefaction: An epoxy waterproof adhesive material of the present disclosure has prominent strength, flexibility, and adhesion after being cured at room temperature, could be re-liquefied at a high temperature after initially being cured, and then could be further cured. Since the epoxy waterproof adhesive material could be re-liquefied after initially being cured, during an actual construction, the epoxy waterproof adhesive material could be re-melted due to a high temperature when a bituminous mix is paved to form an upper layer, such that a waterproof layer is firmly bonded with the upper layer. If a waterproof material could not be re-liquefied, during a construction, an adhesive layer needs to be added to strengthen the interlayer adhesion, otherwise the delamination easily occurs to affect a service life. When used to form a waterproof adhesive layer, the epoxy waterproof adhesive material of the present disclosure could ensure tight bonding of a pavement layer to a steel bridge deck and play a prominent waterproof role.

### DETAILED DESCRIPTION OF THE EMBODIMENTS

The present disclosure will be described in further detail below with reference to examples, but the embodiments of the present disclosure are not limited thereto.

### Example 1

In this example, an epoxy waterproof adhesive material was provided, consisting of a component A and a component B in a mass ratio of 1:0.9.

The component A consisted of the following raw materials in parts by mass:

| | | |
|---|---|---|
| epoxy resin GEFR 170 | 100 | parts |
| ethylene glycol diglycidyl ether | 5 | parts |
| 2-(3,4-epoxycyclohexyl)ethyltrimethoxysilane | 0.6 | part, and |
| a polyester Tech-7205 | 0.6 | part. |

The component B consisted of the following raw materials in parts by mass:

| | | |
|---|---|---|
| a tertiary amine accelerator DMP-30 | 2.5 | parts |
| a polyetheramine accelerator 9133 | 5 | parts |
| oleylamine | 77.5 | parts, and |
| an amino-terminated liquid | 15 | parts. |
| nitrile rubber ATBN 1300 × 16 | | |

A method for preparing the epoxy waterproof adhesive material was performed as follows.
(1) According to the above amount relationship, the epoxy resin GEFR 170, the ethylene glycol diglycidyl ether, and a mixture of the 2-(3,4-epoxycyclohexyl)ethyltrimethoxysilane (A-186) and the polyester Tech-7205 as an adhesion promoter were weighed and mixed to be uniform to obtain the component A for later use.
(2) According to the above amount relationship, the tertiary amine accelerator DMP-30, the polyetheramine accelerator 9133, the oleylamine, and the amino-terminated liquid nitrile rubber ATBN 1300×16 were weighed and mixed to be uniform to obtain the component B for later use.
(3) The component A and the component B were mixed to be uniform in the mass ratio of 1:0.9 to obtain the epoxy waterproof adhesive material.

### Example 2

In this example, an epoxy waterproof adhesive material was provided, consisting of a component A and a component B in a mass ratio of 1:0.9. The component A consisted of the following raw materials in parts by mass:

| | | |
|---|---|---|
| epoxy resin GEFR 170 | 100 | parts |
| ethylhexyl glycidyl ether | 3 | parts |
| 2-(3,4-epoxycyclohexyl)ethyltrimethoxysilane | 0.2 | part, and |
| a the polyester Tech-7205 | 0.8 | part. |

The component B consisted of the following raw materials in parts by mass:

| | | |
|---|---|---|
| a tertiary amine accelerator DMP-30 | 2 | parts |
| a polyetheramine accelerator 9133 | 4.5 | parts |
| oleylamine | 79.5 | parts, and |
| an amino-terminated liquid | 14 | parts. |
| nitrile rubber ATBN 1300 × 16 | | |

A method for preparing the epoxy waterproof adhesive material was performed as follows.
(1) According to the above amount relationship, the epoxy resin GEFR 170, the ethylhexyl glycidyl ether, and a mixture of the 2-(3,4-epoxycyclohexyl)ethyltrimethoxysilane (A-186) and the polyester Tech-7205 as an adhesion promoter were weighed and mixed to be uniform to obtain the component A for later use.
(2) According to the above amount relationship, the tertiary amine accelerator DMP-30, the polyetheramine accelerator 9133, the oleylamine, and the amino-terminated liquid nitrile rubber ATBN 1300×16 were weighed and mixed to be uniform to obtain the component B for later use.
(3) The component A and the component B were mixed to be uniform in the mass ratio of 1:0.9 to obtain the epoxy waterproof adhesive material.

### Example 3

In this example, an epoxy waterproof adhesive material was provided, consisting of a component A and a component B in a mass ratio of 1:0.9. The component A consisted of the following raw materials in parts by mass:

| | | |
|---|---|---|
| epoxy resin GEFR 170 | 100 | parts |
| ethylhexyl glycidyl ether | 7 | parts |
| 2-(3,4-epoxycyclohexyl)ethyltrimethoxysilane | 0.4 | part, and |
| a polyester Tech-7205 | 0.8 | part. |

The component B consisted of the following raw materials in parts by mass:

| | | |
|---|---|---|
| a tertiary amine accelerator DMP-30 | 1.5 | parts |
| a polyetheramine accelerator 9133 | 7 | parts |
| oleylamine | 75 | parts, and |
| an amino-terminated liquid | 16.5 | parts. |
| nitrile rubber ATBN 1300 × 16 | | |

A method for preparing the epoxy waterproof adhesive material was performed as follows.
(1) According to the above amount relationship, the epoxy resin GEFR 170, the ethylhexyl glycidyl ether, and a mixture of the 2-(3,4-epoxycyclohexyl)ethyltrimethoxysilane (A-186) and the polyester Tech-7205 as an adhesion promoter were weighed and mixed to be uniform to obtain the component A for later use.
(2) According to the above amount relationship, the tertiary amine accelerator DMP-30, the polyetheramine accelerator 9133, the oleylamine, and the amino-terminated liquid nitrile rubber ATBN 1300×16 were weighed and mixed to be uniform to obtain the component B for later use.
(3) The component A and the component B were mixed to be uniform in the mass ratio of 1:0.9 to obtain the epoxy waterproof adhesive material.

### Example 4

In this example, an epoxy waterproof adhesive material was provided, consisting of a component A and a component B in a mass ratio of 1:1. The component A consisted of the following raw materials in parts by mass:

| | | |
|---|---|---|
| epoxy resin GEFR 170 | 100 | parts |
| ethylhexyl glycidyl ether | 9 | parts, and |
| a polyester Tech-7205 | 1.4 | part. |

The component B consisted of the following raw materials in parts by mass:

| | | |
|---|---|---|
| a tertiary amine accelerator DMP-30 | 1.5 | parts |
| a polyetheramine accelerator 9133 | 9 | parts |
| oleylamine | 72.5 | parts, and |
| an amino-terminated liquid | 17 | parts. |
| nitrile rubber ATBN 1300 × 16 | | |

A method for preparing the epoxy waterproof adhesive material was performed as follows.
(1) According to the above amount relationship, the epoxy resin GEFR 170, the ethylhexyl glycidyl ether, and the polyester Tech-7205 as an adhesion promoter were weighed and mixed to be uniform to obtain the component A for later use.
(2) According to the above amount relationship, the tertiary amine accelerator DMP-30, the polyetheramine accelerator 9133, the oleylamine, and the amino-terminated liquid nitrile rubber ATBN 1300×16 were weighed and mixed to be uniform to obtain the component B for later use.
(3) The component A and the component B were mixed to be uniform in the mass ratio of 1:1 to obtain the epoxy waterproof adhesive material.

### Example 5

In this example, an epoxy waterproof adhesive material was provided, consisting of a component A and a component B in a mass ratio of 1:1.1. The component A consisted of the following raw materials in parts by mass:

| | | |
|---|---|---|
| epoxy resin GEFR 170 | 100 | parts |
| a reactive diluent AGE | 4 | parts, and |
| 2-(3,4-epoxycyclohexyl)ethyltrimethoxysilane | 0.7 | part. |

The component B consisted of the following raw materials in parts by mass:

| | | |
|---|---|---|
| a tertiary amine accelerator DMP-30 | 3 | parts |
| a polyetheramine accelerator 9133 | 4 | parts |
| oleylamine | 83 | parts, and |
| an amino-terminated liquid | 10 | parts. |
| nitrile rubber ATBN 1300 × 16 | | |

A method for preparing the epoxy waterproof adhesive material was performed as follows.
(1) According to the above amount relationship, the epoxy resin GEFR 170, the reactive diluent AGE, and the 2-(3,4-epoxycyclohexyl)ethyltrimethoxysilane (A-186) as an adhesion promoter were weighed and mixed to be uniform to obtain the component A for later use.
(2) According to the above amount relationship, the tertiary amine accelerator DMP-30, the polyetheramine accelerator 9133, the oleylamine, and the amino-terminated liquid nitrile rubber ATBN 1300×16 were weighed and mixed to be uniform to obtain the component B for later use.
(3) The component A and the component B were mixed to be uniform in the mass ratio of 1:1.1 to obtain the epoxy waterproof adhesive material.

### Comparative Example 1

A commercially-available epoxy waterproof adhesive layer HYP produced by 141-2 Kosaka, Haruki, Togo-cho Aichi-gun, Aichi-ken, Japan, Indai Kasei Co., Ltd.: components A and B were mixed in a mass ratio of 1:1.

### Comparative Example 2

A commercially-available waterproof epoxy resin binder II A produced by Guangzhou Peihe New Materials Co., Ltd, China.: components A and B were mixed in a mass ratio of 1:1.

### Comparative Example 3

In this comparative example, an epoxy waterproof adhesive material was provided, consisting of a component A and a component B in a mass ratio of 1:0.9. The component A consisted of the following raw materials in parts by mass:

| | | |
|---|---|---|
| epoxy resin GEFR 170 | 100 | parts |
| ethylhexyl glycidyl ether | 9 | parts, and |
| a polyester Tech-7205 | 1.4 | part. |

The component B consisted of the following raw materials in parts by mass:

| | | |
|---|---|---|
| a tertiary amine accelerator DMP-30 | 2 | parts |
| benzyl alcohol | 6.5 | parts |
| oleylamine | 75 | parts, and |
| an amino-terminated liquid | 16.5 | parts. |
| nitrile rubber ATBN 1300 × 16 | | |

A method for preparing the epoxy waterproof adhesive material was performed as follows:
(1) According to the above amount relationship, the epoxy resin GEFR 170, the ethylhexyl glycidyl ether, and the polyester Tech-7205 as an adhesion promoter were weighed and mixed to be uniform to obtain the component A for later use.
(2) According to the above amount relationship, the tertiary amine accelerator DMP-30, the benzyl alcohol, the oleylamine, and the amino-terminated liquid nitrile rubber ATBN 1300×16 were weighed and mixed to be uniform to obtain the component B for later use.
(3) The component A and the component B were mixed to be uniform in the mass ratio of 1:0.9 to obtain the epoxy waterproof adhesive material.

### Comparative Example 4

In this comparative example, an epoxy waterproof adhesive material was provided, consisting of a component A and a component B in a mass ratio of 1:0.9. The component A consisted of the following raw materials in parts by mass:

| | | |
|---|---|---|
| epoxy resin GEFR 170 | 100 | parts |
| ethylhexyl glycidyl ether | 9 | parts, and |
| a polyester Tech-7205 | 1.4 | parts. |

The component B consisted of the following raw materials in parts by mass:

| | | |
|---|---|---|
| benzyl alcohol | 6.5 | parts |
| dodecylamine | 77.5 | parts, and |
| an amino-terminated liquid | 16 | parts. |
| nitrile rubber ATBN 1300 × 16 | | |

A method for preparing the epoxy waterproof adhesive material was performed as follows.
(1) According to the above amount relationship, the epoxy resin GEFR 170, the ethylhexyl glycidyl ether, and the polyester Tech-7205 as an adhesion promoter were weighed and mixed to be uniform to obtain the component A for later use.
(2) According to the above amount relationship, the benzyl alcohol, the dodecylamine, and the amino-terminated liquid nitrile rubber ATBN 1300×16 were weighed and mixed to be uniform to obtain the component B for later use.
(3) The component A and the component B were mixed to be uniform in the mass ratio of 1:0.9 to obtain the epoxy waterproof adhesive material.

### Test Methods

Mechanical property tests: A tensile strength and an elongation at break were determined in accordance with GB/T 1040.3-2006. A steel-steel tension-shearing strength was determined in accordance with GB/T 7124-2008. A steel-steel bonding strength was determined in accordance with GB/T 6329-1996.

Surface drying time: A mixed adhesive solution was paved in a mold with a groove depth of 2 mm, a length of 15 cm, and a width of 10 cm, then the mold was placed in an incubator, a time taken for a surface of an adhesive film to become non-sticky was determined.

Mortar block bonding test: The epoxy waterproof adhesive materials prepared in Examples 1 to 5 and Comparative Examples 1 to 4 each were evenly paved in a mortar block bonding region. After the sample preparation, each sample was immediately cured at 60° C. for 4 d, then a slider preheated in a 165° C. oven for 4 h was bonded to a substrate coated with the epoxy waterproof adhesive material. A resulting bonded product was placed for 3 d at room temperature for later use. A bonding strength was determined in accordance with GB/T 16777-2008.

Test of re-liquefaction after curing: A tensile sample was cured at 60° C. for 4 d and then placed in an oven at a set temperature, and whether the sample was liquefied and leveled was observed.

TABLE 1
Surface drying time and re-liquefaction performance after
curing of the epoxy waterproof adhesive materials

| | Surface | | Liquefaction |
|---|---|---|---|
| | drying time¹ | Whether it | temperature |
| Item | (min, 30° C.) | is liquefied² | (° C.) |
| Example 1 | 420 | Yes | 150 |
| Example 2 | 435 | Yes | 130 |
| Example 3 | 432 | Yes | 130 |
| Comparative | 418 | Yes | 140 |
| Example 1 | | | |
| Comparative | 243 | No | — |
| Example 2 | | | |
| Comparative | 440 | No | — |
| Example 3 | | | |
| Comparative | 485 | No | — |
| Example 4 | | | |

Notes:
¹The surface drying time is data measured for the component A and the component B of the epoxy waterproof adhesive material that are mixed according to the mass ratios in Examples 1 to 3 or Comparative Examples 1 to 4 and then cured.
²When a material is not liquefied at a maximum temperature of 200° C., it is determined that the material cannot be liquefied.

TABLE 2
Mechanical properties of the epoxy
waterproof adhesive materials (unit: MPa)

| | Metal bonding | | Mortar | | | |
|---|---|---|---|---|---|---|
| | | Steel- | block bonding¹ | | | |
| | Steel- | steel | | De- | | Elongation |
| | steel | tension- | Bonding | struction | Tensile | at break |
| Item | bonding | shearing | strength | mode | strength | (%) |
| Example 1 | 13.24 | 12.95 | 2.92 | Mortar | 11.01 | 185.6 |
| | | | | block | | |
| Example 2 | 7.36 | 8.03 | 2.81 | Mortar | 5.51 | 267.9 |
| | | | | block | | |
| Example 3 | 5.68 | 6.14 | 2.86 | Mortar | 4.53 | 302.7 |
| | | | | block | | |
| Com- | 5.07 | 5.20 | 1.57 | Com- | 3.75 | 256.4 |
| parative | | | | posite | | |
| Example 1 | | | | | | |
| Com- | 12.15 | 11.94 | —² | Interface | 9.45 | 167.3 |
| parative | | | | | | |
| Example 2 | | | | | | |
| Com- | 4.76 | 4.91 | —² | Interface | 3.01 | 157.1 |
| parative | | | | | | |
| Example 3 | | | | | | |
| Com- | 4.05 | 4.31 | —² | Interface | 2.87 | 177.7 |
| parative | | | | | | |
| Example 4 | | | | | | |

Notes:
¹The mortar block destruction means that a destruction occurs at a mortar block side. The interface destruction means that the destruction occurs at an adhesive interface between the mortar block and the epoxy waterproof adhesive material. The composite destruction means that the destruction occurs at both the mortar block destruction and interface destruction.
²A slider is not bonded with a sample, and the slider falls off when the sample is taken out.

It can be seen from Table 1 that the epoxy waterproof adhesive material prepared in the present disclosure has the characteristics of a long construction holding time and re-liquefaction after initial curing. Examples 1 to 3 have a surface drying time of about 7 h, which is similar to a surface drying time of Comparative Example 1 (the epoxy waterproof adhesive material produced outside China), and each could be re-liquefied. Comparative Example 2 has a surface drying time of only about 4 h, and could not be re-liquefied after initially being cured. Comparative Examples 3 and 4 have a long surface drying time, but both could not be re-liquefied.

It can be seen from Table 2 that the epoxy waterproof adhesive material prepared in the present disclosure has the characteristics of high strength, prominent flexibility, excellent adhesion, adjustable performance, and wide applicability. For example, the epoxy waterproof adhesive material in Example 1 has a steel-steel bonding strength, a steel-steel tension-shearing strength, and a mortar block bonding strength of 13.24 MPa, 12.95 MPa, and 2.92 MPa, respectively (mortar block destruction), and a tensile strength and an elongation at break of 11.01 MPa and 185.6%, respectively. Example 3 has a steel-steel bonding strength, a steel-steel tension-shearing strength, a mortar block bonding strength, a tensile strength, and an elongation at break of 5.68 MPa, 6.14 MPa, 2.86 MPa (mortar block destruction), 4.53 MPa, and 302.7%, respectively. It can be seen that, through the adjustment of components, the present disclosure could achieve the transformation from a high strength and a low elasticity to a low strength and a high elasticity, and could allow excellent interfacial adhesion for either a metal substrate or a cement mortar block. The comprehensive performance of Examples 1, 2, and 3 is also significantly higher than the comprehensive performance of Comparative Examples 1, 2, 3, and 4. Comparative Example 1 has a mortar block bonding strength of only 1.57 MPa and undergoes a composite destruction, indicating ordinary bonding performance for a cement concrete substrate. For Comparative Examples 2 to 4, due to the lack of a re-liquefaction ability, a sample has basically no bonding strength to a mortar block, which is not conducive to the interlayer bonding between pavement layers.

In summary, the epoxy waterproof adhesive material prepared in the present disclosure has characteristics such as excellent interfacial adhesion, high strength, prominent flexibility, adjustable performance, excellent waterproofness, and could be re-liquefied at a high temperature after initially being cured.

The above descriptions are merely preferred implementations of the present disclosure. It should be noted that a person of ordinary skill in the art may further make several improvements and modifications without departing from the principle of the present disclosure, but such improvements and modifications should be deemed as falling within the scope of the present disclosure.

What is claimed is:

1. An epoxy waterproof adhesive material, comprising a component A and a component B, with a mass ratio of the component A to the component B being a range of 1:(0.8-1.2), wherein
the component A comprises the following raw materials in parts by mass:

| | |
|---|---|
| an epoxy resin | 100 parts |
| a reactive diluent | 2 parts to 10 parts, and |
| an adhesion promoter | 0.5 part to 1.5 parts; and |

the component B comprises the following raw materials in parts by mass:

| | |
|---|---|
| a curing accelerator | 4 parts to 12 parts |
| a curing agent | 70 parts to 85 parts; and |
| a liquid rubber | 8 parts to 20 parts. |

2. The epoxy waterproof adhesive material of claim 1, wherein the epoxy resin is a bisphenol F epoxy resin; and
the reactive diluent is at least one selected from the group consisting of ethylhexyl glycidyl ether, ethylene glycol diglycidyl ether, and alkyl (C12-C14) glycidyl ether (AGE).

3. The epoxy waterproof adhesive material of claim 2, wherein the bisphenol F epoxy resin is GEFR 170.

4. The epoxy waterproof adhesive material of claim 1, wherein the adhesion promoter is at least one selected from the group consisting of 2-(3,4-epoxycyclohexyl)ethyltrimethoxysilane and a polyester Tech-7205.

5. The epoxy waterproof adhesive material of claim 1, wherein the curing accelerator is at least one selected from the group consisting of a tertiary amine accelerator 2,4,6-tri(dimethylaminoethyl)phenol (DMP-30) and a polyetheramine accelerator 9133; the curing agent is oleylamine; and the liquid rubber is an amino-terminated liquid nitrile rubber ATBN 1300×16.

6. The epoxy waterproof adhesive material of claim 1, wherein the mass ratio of the component A to the component B is 1:0.9.

7. The epoxy waterproof adhesive material of claim 1, wherein the mass ratio of the component A to the component B is 1:1.0.

8. The epoxy waterproof adhesive material of claim 1, wherein the mass ratio of the component A to the component B is 1:1.1.

9. The epoxy waterproof adhesive material of claim 6, wherein the component A comprises the following raw materials in parts by mass:

| | | |
|---|---|---|
| epoxy resin GEFR 170 | 100 | parts |
| ethylene glycol diglycidyl ether | 5 | parts |
| 2-(3,4-epoxycyclohexyl)ethyltrimethoxysilane | 0.6 | part, and |
| a polyester Tech-7205 | 0.6 | part; and |

the component B comprises the following raw materials in parts by mass:

| | | |
|---|---|---|
| a tertiary amine accelerator DMP-30 | 2.5 | parts |
| a polyetheramine accelerator 9133 | 5 | parts |
| oleylamine | 77.5 | parts, and |
| an amino-terminated liquid | 15 | parts. |
| nitrile rubber ATBN 1300 × 16 | | |

10. The epoxy waterproof adhesive material of claim 6, wherein the component A comprises the following raw materials in parts by mass:

| | | |
|---|---|---|
| epoxy resin GEFR 170 | 100 | parts |
| ethylhexyl glycidyl ether | 3 | parts |
| 2-(3,4-epoxycyclohexyl)ethyltrimethoxysilane | 0.2 | part, and |
| a polyester Tech-7205 | 0.8 | part; and |

the component B comprises the following raw materials in parts by mass:

| | | |
|---|---|---|
| a tertiary amine accelerator DMP-30 | 2 | parts |
| a polyetheramine accelerator 9133 | 4.5 | parts |
| oleylamine | 79.5 | parts, and |
| an amino-terminated liquid | 14 | parts. |
| nitrile rubber ATBN 1300 × 16 | | |

11. The epoxy waterproof adhesive material of claim 6, wherein the component A comprises the following raw materials in parts by mass:

| | | |
|---|---|---|
| epoxy resin GEFR 170 | 100 | parts |
| ethylhexyl glycidyl ether | 7 | parts |
| 2-(3,4-epoxycyclohexyl)ethyltrimethoxysilane | 0.4 | part, and |
| a polyester Tech-7205 | 0.8 | part; and |

the component B comprises the following raw materials in parts by mass:

| | | |
|---|---|---|
| a tertiary amine accelerator DMP-30 | 1.5 | parts |
| a polyetheramine accelerator 9133 | 7 | parts |
| oleylamine | 75 | parts, and |
| an amino-terminated liquid | 16.5 | parts. |
| nitrile rubber ATBN 1300 × 16 | | |

12. The epoxy waterproof adhesive material of claim 7, wherein the component A comprises the following raw materials in parts by mass:

| | | |
|---|---|---|
| epoxy resin GEFR 170 | 100 | parts |
| ethylhexyl glycidyl ether | 9 | parts, and |
| a polyester Tech-7205 | 1.4 | part; and |

the component B comprises the following raw materials in parts by mass:

| | | |
|---|---|---|
| a tertiary amine accelerator DMP-30 | 1.5 | parts |
| a polyetheramine accelerator 9133 | 9 | parts |
| oleylamine | 72.5 | parts, and |
| an amino-terminated liquid | 17 | parts. |
| nitrile rubber ATBN 1300 × 16 | | |

13. The epoxy waterproof adhesive material of claim 8, wherein the component A comprises the following raw materials in parts by mass:

| | | |
|---|---|---|
| epoxy resin GEFR 170 | 100 | parts |
| a reactive diluent AGE | 4 | parts, and |
| 2-(3,4-epoxycyclohexyl)ethyltrimethoxysilane | 0.7 | part; and |

the component B comprises the following raw materials in parts by mass:

| | |
|---|---|
| a tertiary amine accelerator DMP-30 | 3 parts |
| a polyetheramine accelerator 9133 | 4 parts |
| oleylamine | 83 parts, and |
| an amino-terminated liquid | 10 parts. |
| nitrile rubber ATBN 1300 × 16 | |

14. A method for preparing the epoxy waterproof adhesive material of claim 1, comprising the following steps:
(1) weighing 100 parts by mass of the epoxy resin, 2 parts by mass to 10 parts by mass of the reactive diluent, and 0.5 part by mass to 1.5 parts by mass of the adhesion promoter, and mixing to obtain the component A;
(2) weighing 4 parts by mass to 12 parts by mass of the curing accelerator, 70 parts by mass to 85 parts by mass of the curing agent, and 8 parts by mass to 20 parts by mass of the liquid rubber, and mixing to obtain the component B; and
(3) mixing the component A and the component B in the mass ratio of 1:(0.8-1.2) to obtain the epoxy waterproof adhesive material.

15. A method of using the epoxy waterproof adhesive material of claim 1, comprising using the epoxy waterproof adhesive material in a waterproof adhesive layer for a steel bridge deck or a concrete bridge deck.

16. The epoxy waterproof adhesive material of claim 2, wherein the mass ratio of the component A to the component B is 1:0.9.

17. The epoxy waterproof adhesive material of claim 2, wherein the mass ratio of the component A to the component B is 1:1.0.

18. The epoxy waterproof adhesive material of claim 2, wherein the mass ratio of the component A to the component B is 1:1.1.

19. The method claim 14, wherein the epoxy resin is a bisphenol F epoxy resin; and
the reactive diluent is at least one selected from the group consisting of ethylhexyl glycidyl ether, ethylene glycol diglycidyl ether, and AGE.

20. The method of claim 14, wherein the adhesion promoter is at least one selected from the group consisting of 2-(3,4-epoxycyclohexyl)ethyltrimethoxysilane and a polyester Tech-7205.
